(19) United States
(12) Patent Application Publication
(10) Pub. No.: US 2025/0103894 A1
(43) Pub. Date: Mar. 27, 2025

(54) RETRIEVAL OPTIMIZATION USING REINFORCEMENT LEARNING

(71) Applicant: Roku, Inc., San Jose, CA (US)

(72) Inventors: Abhishek Majumdar, Santa Clara, CA (US); Yuxi Liu, Mountain View, CA (US); Kapil Kumar, London (GB); Nitish Aggarwal, Sunnyvale, CA (US); Manasi Deshmukh, San Francisco, CA (US); Danish Nasir Shaikh, Daly City, CA (US); Ravi Tiwari, San Jose, CA (US)

(73) Assignee: Roku, Inc., San Jose, CA (US)

(21) Appl. No.: 18/423,825

(22) Filed: Jan. 26, 2024

Related U.S. Application Data
(60) Provisional application No. 63/584,355, filed on Sep. 21, 2023.

(51) Int. Cl. G06N 3/092; G06F 16/2457; G06N 3/0455

(52) U.S. Cl. CPC G06N 3/092; G06F 16/24578; G06N 3/0455

(57) ABSTRACT

Retrieving content items in response to a query in a way that increases user satisfaction and increases chances of users consuming a retrieved content item is not trivial. One retrieval strategy may include dividing the content items into buckets according to a dimension about the content items and retrieving a top K number of items from different buckets to balance semantic affinity and the dimension. Choosing an optimal K for different buckets for a given query can be a challenge. Reinforcement learning can be used to train and implement an agent model that can choose the optimal K for different buckets.

### CROSS-REFERENCE TO RELATED APPLICATIONS

This non-provisional application claims priority to and/or receives benefit from provisional application, titled “RETRIEVAL OPTIMIZATION USING REINFORCEMENT LEARNING”, Ser. No. 63/584,355, filed on Sep. 21, 2023. The provisional application is hereby incorporated by reference in its entirety.

### TECHNICAL FIELD

This disclosure relates generally to reinforcement learning, and more specifically, using reinforcement learning to optimize content item retrieval from buckets.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates bucketizing content items, according to some embodiments of the disclosure.

FIG. 2 illustrates content item retrieval using buckets, according to some embodiments of the disclosure.

FIG. 3A-B illustrate using reinforcement learning to obtain an agent model that can output optimized K's for content item retrieval, according to some embodiments of the disclosure.

FIG. 4A illustrates an exemplary excerpt of world parameters, according to some embodiments of the disclosure.

FIG. 4B illustrates exemplary world parameters, according to some embodiments of the disclosure.

FIG. 5 illustrates exemplary agent model flow, according to some embodiments of the disclosure.

FIG. 6 illustrates an exemplary episode having one or more rounds, according to some embodiments of the disclosure.

FIG. 7 is a flow chart illustrating operations performed in a round of an episode, according to some embodiments of the disclosure.

FIG. 8 is a flowchart illustrating operations for training and/or updating an agent model using round results, according to some embodiments of the disclosure.

FIG. 9 is a flowchart showing a method for training and/or updating parameters of an agent model, according to some embodiments of the disclosure.

FIG. 10 is a block diagram of an exemplary computing device, according to some embodiments of the disclosure.

### DETAILED DESCRIPTION

### Overview

Content platforms offer users access to large libraries of content items. Users can spend a lot of time on a content platform to look for content items to consume. Finding the content items that a user is looking for can be important for user satisfaction. If a user is not satisfied, the user is likely not going to return to the content platform. Also, if a user is not satisfied, the user is likely not going to consume any content items.

Retrieving content items in response to a query in a way that increases user satisfaction and increases chances of users consuming a retrieved content item is not trivial. A query may include a natural language description of what a user is searching for or looking for in a library of content items.

One retrieval strategy may include dividing the content items into buckets according to a dimension about the content items and retrieving a top K number of items from different buckets to balance semantic affinity and the dimension. A naïve approach is to use fixed K's for different buckets for any query. However, such naïve approach may retrieve too many content items from a particular bucket and/or too few content items from a particular bucket for a given query because the K's are not adaptable. In some cases, such naïve approach may not adapt to contextual factor(s). In an adaptive approach, K's can be optimized for the query and optionally the contextual factor(s). The query and one or more contextual factors together can form a context for content item retrieval. However, choosing an optimal K for different buckets for a given query and optionally contextual factor(s) can be a challenge. Reinforcement learning can be used to train and implement an agent model that can choose the optimal K for different buckets.

Reinforcement learning can be beneficial because the technique does not require a large set of high quality prior labeled data. Instead, an agent model can complete rounds and episodes in a simulated environment. In some cases, an agent model can also learn from real users completing rounds and episodes. Rounds and episodes can explore the simulated environment to discover patterns and/or trends and does not depend on supervised training data. The rounds and episodes can be used to train the agent model to optimize for an action with the highest long-term reward for a given query.

The described reinforcement technique has unique features relating to the simulated environment (also referred herein as the world parameters), design of the rounds and episodes, the agent model (including the action the agent model takes), and design of rewards. Herein, an episode may include one or more rounds. The unique features are implemented for determining and optimizing K's for the different buckets for a given context comprising a query. The unique features can choose K's that optimizes long-term reward and success with users long-term.

Challenges with Semantic Search in a Content Retrieval System

Content providers may manage and allow users to access and view thousands to millions or more content items. Content items may include media content, such as audio content, video content, image content, augmented reality content, virtual reality content, mixed reality content, game, textual content, interactive content, etc. Finding exactly what a user is looking for, or finding what the user may find most relevant can greatly improve the user experience. In some cases, a user may provide voice-based or text-based queries to find content items. Examples of queries may include:
“Show me funny office comedies with romance”
“TV series with strong female characters”
“I want to watch 1980s romantic movies with a happy ending”
“Short animated film that talks about family values”
“Are there blockbuster movies from 1990s that involves a tragedy?”
“What is that movie where there is a Samoan warrior and a girl going on a sea adventure?
“What are some most critically-acclaimed dramas right now?” and
“I want to see a film set in Tuscany but is not dubbed in English.”

Machine learning models can be effective in interpreting a query and finding content items that may match with the query. Machine learning models may implement natural language processing to interpret the query. Machine learning models may include one or more neural networks (e.g., transformer-based neural networks). Machine learning models may include a large language model (LLM). User experience with retrieval of content items in response to a query can depend on whether the machine learning models can retrieve content items that the user is looking for in the query.

Machine learning models may retrieve content items that are most semantically relevant or have highest semantic affinity to the query. In other words, machine learning models may retrieve top content items along a single dimension, attribute, or feature about the content items. Besides semantic relevance/affinity, content items may have one or more other dimensions, attributes, or features that could make a content item more relevant to a user in response to a query. Examples of dimensions, attributes, or features of content items may include: popularity, topicality, trend, statistical change, most-talked or most-discussed about, critics ratings, viewers ratings, length/duration, demographic-specific popularity, segment-specific popularity, region-specific popularity, cost associated with a content item, revenue associated with a content item, subscription associated with a content item, amount of advertising, etc. Some other examples of features, attributes, or dimensions of content items may include qualitative and/or quantitative aspects about content items. Qualitative and/or quantitative aspects about content items may include, e.g., popularity (e.g., topical, trending, most-talked about, etc.), popularity among certain demographics of users that consumes the content items, popularity among different devices used for consuming the content items, which cluster(s) the content items belong to, associated revenue generated from the content items, associated revenue that can be generated from the content item, viewer ratings, critic ratings, type of media, etc. In some cases, users may find content items more relevant when the retrieved content items have a balance between semantic affinity and one or more other dimensions, attributes, or features about the content items.

Balancing Semantic Affinity with Other Dimensions, Features, or Attributes of the Content Items

One approach to balancing semantic affinity and one or more other dimensions or features about the content items is by bucketizing (or clustering) content items and enforcing a number of most semantically relevant content items to be retrieved from each bucket (or cluster). As a result, content item retrieval can balance semantic relevance with one or more other dimensions or features when content items across a spectrum along one or more dimensions or content items having diverse features or attributes are retrieved.

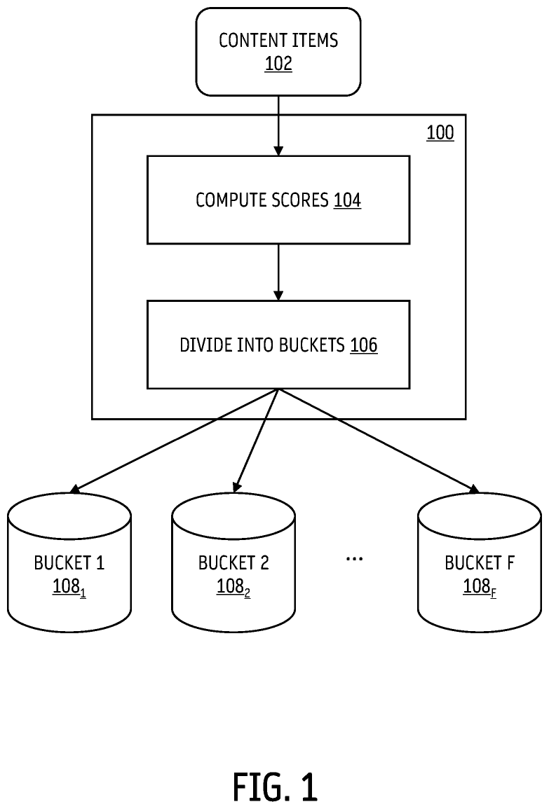

FIG. 1 illustrates bucketizing content items 102, according to some embodiments of the disclosure. Content items 102 can be bucketized by an exemplary technique 100 and split into F number of buckets (F>1), shown as bucket 1 108₁, bucket 2 108₂, . . . bucket F 108_{F}. In 104, one or more scores may be computed or determined for each content item in content items 102. A score may quantify a dimension or feature of a content item. An exemplary score is a popularity score (measuring the amount of user interactivity a content item has received in the past D number of days). Another exemplary score is a critics' rating. Yet another exemplary score is a viewers' rating. In 106, content items can be divided into buckets (or clusters) using the one or more scores computed for each content item.

In some cases, the one or more scores may be used to compute a single score for each content item. The single score may be normalized across content items. One exemplary strategy to divide the content items into buckets in 106 using the single score may include implementing a recursive Pareto distribution approach to recursively split content items, e.g., a 80%-20% split, and place some content items into a bucket at each split until a desired number of buckets have been reached. Another exemplary strategy to divide the content items in 106 using the single score may include implementing a percentile distribution approach, e.g., splitting content items based on percentile group that the content items belong to. Percentile groups may include 90^{th} percentile group, 80^{th} percentile group, 70^{th} percentile group, . . . and so forth. Yet another exemplary strategy to divide the content items into buckets in 106 using the single score may include implementing a geometric progression based distribution approach, e.g., according to a geometric sequence, starting with a base group number of content items and growing the number of content items for the next bucket geometrically. In some cases, the one or more scores may be used in a clustering method to find buckets or clusters of content items with similar scores.

In some cases, technique 100 to bucketize content items 102 may include dividing content items 102 into buckets (or clusters) using cluster analysis such as k-means clustering, distribution-based clustering, density based clustering, etc. Identified clusters of content items can be assigned to different buckets. In some cases, one or more scores determined about the content items may be used as input features to a model (e.g., a machine learning model) to determine to which bucket or cluster a content item belongs. In some cases, metadata about the content items may be used as input features to a model (e.g., a machine learning model) to determine to which bucket or cluster a content item belongs. In some cases, dimensions/features about the content items may be used as input features to a model (e.g., a machine learning model) to determine to which bucket or cluster a content item belongs.

In some cases, technique 100 to bucketize content items 102 may include dividing content items 102 based on one or more dimensions and/or features (e.g., tags, metadata, etc.). about content items 102. For example, content items 102 may be divided into buckets based on the source of the content items (e.g., one bucket with content items from a first media company, one bucket with content items from a second media company, etc.). In another example, content items 102 may be divided into buckets based on type of the content item (e.g., movie, audio, podcast, series, limited series, augmented reality content, virtual reality content, game, live content, sports event, etc.). In yet another example, content items 102 may be divided based on demographics (e.g., one bucket with content items popular with age 2-6, one bucket with content items popular with age 7-12, one bucket with content items popular with age 13-18, one bucket with content items popular with age 19-35, one bucket with content items popular with age 35-55, etc.). In yet another example, content items 102 may be divided based on revenue associated with the content items (e.g., one bucket with content items that are free, one bucket with content items that are free with subscription, one bucket with content items that are free with advertisements, one bucket with content items that can be rented, one bucket with content items that can be purchased for less than a first threshold amount, one bucket with content items that can be purchased for less than a second threshold amount, etc.).

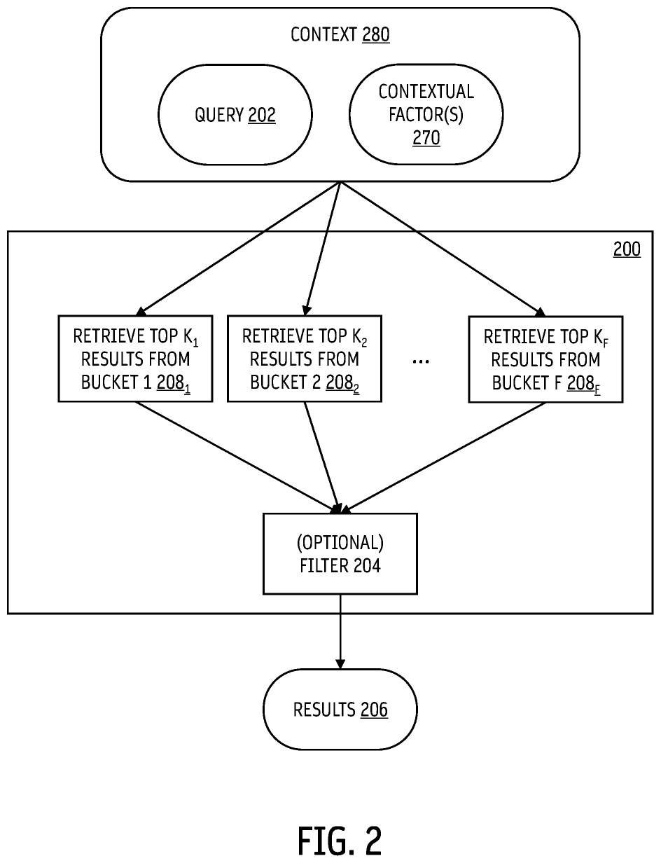

FIG. 2 illustrates content item retrieval using buckets, according to some embodiments of the disclosure. A user may provide query 202. Query 202 may be part of context 280. Context 280 may include query 202. Context 280 may include one or more contextual factors 270. Examples of contextual factors 270 can include: characteristic(s) about the user making the query, time of day, day of the week, time of the year, seasonality (e.g., seasons, special events, holidays, etc.), one or more past queries made by the user, one or more past user interactivity information with the content platform (e.g., what the user clicked on, etc.), whether the query is voice-based or text-based, the type of device that the user is using (e.g., mobile device versus television), the type of application that the user is using, whether the user is a paid subscriber or not, what subscriptions the user has, demographics about the user, whether the user is an expert/experienced user or not, whether the user is a loyal user or not, how many retrieved content items the user is looking for, etc.

Query 202 and optionally one or more contextual factors 270 may be applied to different buckets in technique 200 to generate results 206. Results 206 may include retrieved content items for query 202. Technique 200 may include F number of (parallel) operations to retrieve top K results from F number of different buckets. Exemplary operations are shown as retrieve top K₁ results from bucket 1 208₁, retrieve top K₂ results from bucket 2 208₂, . . . and retrieve top K_{F} results from bucket F 208_{F}.

An operation to retrieve top K results from a bucket may include inputting query 202 into a model (e.g., a language-based model or semantic language model) to extract a query embedding (e.g., a vector of features). In some cases, an option to retrieve top K results from a bucket may include inputting context 280 into a model to extract a context embedding (e.g., a vector of features). Data about content items (e.g., metadata about content items, one or more dimensions/features about content items) may also be input into the model to extract content item features (e.g., a vector of features) corresponding to individual content items. The operation may perform a dot product of the query embedding with each content item features and collect the results of the dot products. In some cases, the operation may perform a dot product of the context embedding with each content item features and collect the results of the dot products. K number of content items having the highest dot product results may be returned. Top K_{f} (f=1, 2, . . . . F) content items returned from the operations to retrieve top K_{f} results from the F number of different buckets can be output as results 206.

In some cases, filter 204 may optionally filter out or remove a number of items from the collection of top K_{f} results from the F number of different buckets. Filter 204 may trim down the collection before outputting the retrieved content items as results 206. Filter 204 may compute and/or determine one or more metrics for each one of top K_{f} results from the F number of different buckets. Filter 204 may filter out a number of content items having one or more metrics that do not meet one or more criteria. In some embodiments, filter 204 may remove retrieved content items that have a semantic affinity score that is below a threshold. In some cases, filter 204 may keep a number of items from the collection. Filter 204 may keep a number of content items having one or more metrics that meet one or more criteria. In some embodiments, filter 204 may keep retrieved content items that have a semantic affinity score that is above a threshold.

### Optimizing K's for Different Buckets Using Reinforcement Learning

In some cases, the K's may be fixed and does not change for a given query. In some cases the K's may be fixed and does not change for a given context. In some cases, the K's may be the same across the different buckets, and does not change for a given query. In some cases, the K's may be the same across the different buckets, and does not change for a given context. For certain queries, changing the K's based on the given query can improve the retrieved content items because having more retrieved content items from one bucket than another bucket may capture a dimension, attribute, or feature of the query better. For certain contexts, changing the K's based on the given context can improve the retrieved content items because having more retrieved content items from one bucket than another bucket may capture a dimension, attribute, or feature of the context (e.g., one or more contextual factors) better.

For example, if a query includes “show me niche vampire comedy TV shows”, user experience and/or engagement with a content item retrieval system may improve when more content items are retrieved from buckets where popularity scores are low, than buckets where popularity scores are high. If a query includes “action”, user experience and/or engagement with a content item retrieval system may improve when more content items are retrieved from buckets where popularity scores are high, than buckets where popularity scores are low. If a query includes “competitive fishing”, user experience and/or engagement with a content item retrieval system may improve when more content items are retrieved from buckets where popularity scores are low, than buckets where popularity scores are high. Without prior labeled training data, it can be a challenge to determine optimal K's for content item retrieval from different buckets for a given query.

For example, if a context includes a query “show me horror movies” and a contextual factor indicates it is near Halloween time, user experience and/or engagement with a content item retrieval system may improve when more content items are retrieved from buckets where popularity scores are high, than buckets where popularity scores are low. If a context includes query “show me travel shows” and a contextual factor indicates the user is located in a specific country, user experience and/or engagement with a content item retrieval system may improve when more content items are retrieved from buckets with content items having content about a different country than the specific country, than buckets where content items having content from the specific country. If a context includes query “show me reality TV” and a contextual factor indicates the user is using a mobile device, user experience and/or engagement with a content item retrieval system may improve when more content items are retrieved from buckets with content items having shorter length, than buckets where content items having a longer length.

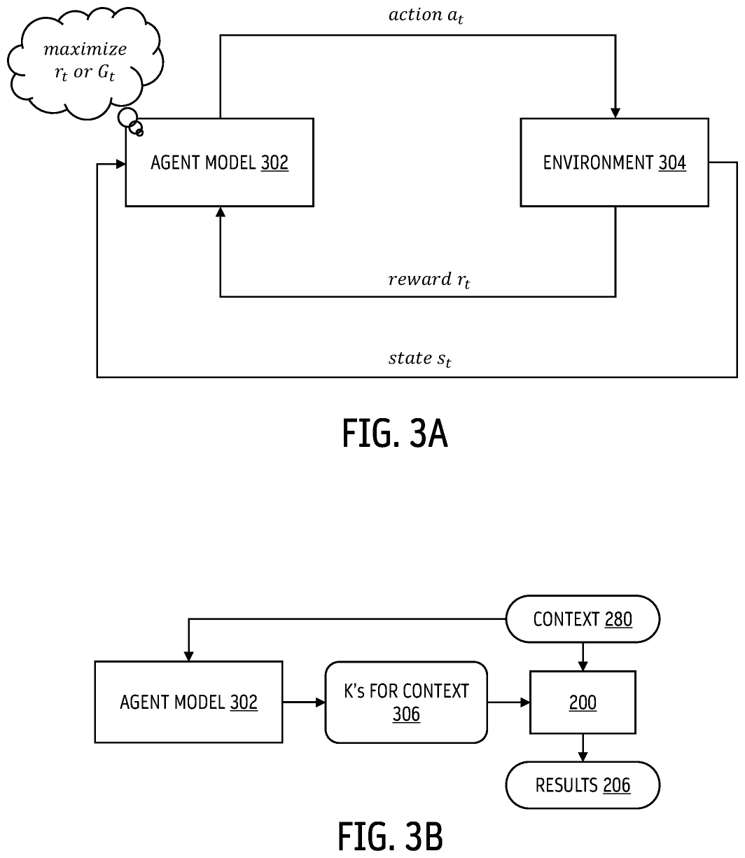

FIGS. 3A-B illustrates using reinforcement learning to obtain an agent model 302 that can output optimized K's for content item retrieval, according to some embodiments of the disclosure. FIG. 3A illustrates a reinforcement learning system, which can include an agent model 302 and an environment 304. FIG. 3B illustrates an exemplary content item retrieval system is illustrated as query 202, technique 200, and results 206. Agent model 302 trained using reinforcement learning system in FIG. 3A can be used in the content item retrieval system in FIG. 3B. Agent model 302 trained using reinforcement learning system in FIG. 3A can be used in the content item retrieval system in FIG. 3B. Agent model 302 may include a model that can determine (optimal) K's 306 for a given context having a query and optionally one or more contextual factors, where the K's 306 can be used in a content item retrieval system (e.g., search and recommendation system). K's 306 generated by agent model 302 based on context 280 may be used as the K's used in technique 200, defining a number of content items to retrieve for each one of the F different buckets to return by technique 200 as results 206.

Referring back to FIG. 3A, agent model 302 may be given a version of the environment 304 as determined by state sₜ. Based on the knowledge of agent model 302 and a current strategy (e.g., a current policy or current parameters of the agent model 302), agent model 302 can take an action aₜ. Taking an action aₜ may allow agent model 302 to explore for new opportunities or explore new behaviors. On the basis of the action aₜ, the environment 304 may give a reward rₜ. The reward rₜ can be determined based on world parameters of environment 304 (e.g., indicators of positive and negative interactions). The reward can be used to update a new observed state, e.g., state sₜ₊₁. The reward can be used to update the strategy (e.g., policy or parameters) of agent model 302 based on how well or poorly agent model 302 performed in the exploration. The agent model 302 may maximize expected long-term rewards Gₜ:

$${G}_{t} = {r}_{t + 1} + γ {r}_{t + 2} + {γ}^{2} {r}_{t + 3} + … = {\sum }_{j = 0}^{T} {γ}^{j} {r}_{t + j + 1}$$

Round rewards rₜ may include a reward for a given round (e.g., measuring instantaneous or immediate reward). Reinforcement learning optimizing rₜ can learn to maximize instant rewards. Expected long-term rewards Gₜ may include a weighted sum of round rewards rⱼ at different rounds of an episode (e.g., an episode may include 20 or fewer rounds), including a current round and one or more future/subsequent rounds in an episode. Gₜ thus not only encompasses the instantaneous and immediate round reward, Gₜ encompasses expected future rewards in an episode of rounds. For example, expected long-term reward Gₜ at round 1 of an episode involving 20 rounds may include a weighted sum of round rewards of rₜ for the 20 rounds. Weights are represented as parameter γ, which can be set or adjusted to vary the amount of impact future round rewards rₜ, rₜ₊₁, rₜ₊₂, . . . may have on long-term rewards Gₜ. Reinforcement learning optimizing Gₜ can thus lean to maximize long-term rewards and learn the impact of the action aₜ taken by agent model 302 long-term.

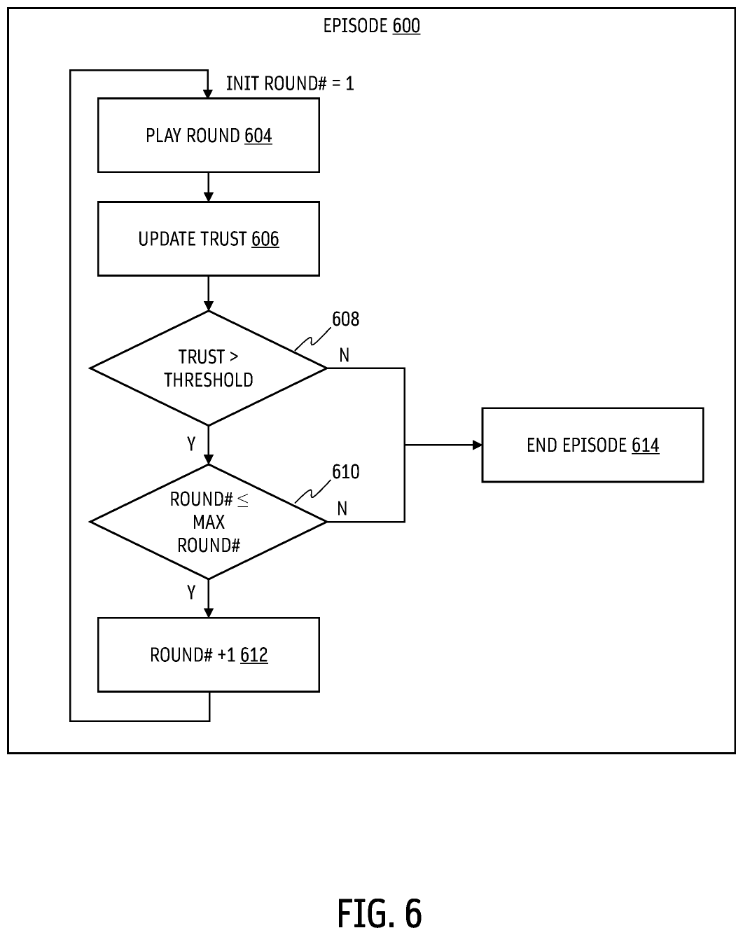

Agent model 302 in FIG. 3A may explore the environment 304 over many rounds and episodes. An example of an episode is shown and described in FIG. 6. Accordingly, agent model 302 can learn from the exploration based on the reward given by environment 304. Using the reward, the strategy, policy, and parameters of agent model 302 can be trained by the exploration and updated to select K's that maximize long-term rewards.

The agent model 302 may observe a state sₜ, which may include a context comprising the input query made by a simulated user and optionally one or more contextual factors. The state space may describe the observation the agent model 302 makes, before taking an action aₜ. For semantic retrieval of content items, the state space may include a query embedding generated by a query semantic model using the input query made by the simulated user. In some cases, the state space may include a context embedding generated by a model using the context comprising the input query and one or more contextual factors.

Given the state sₜ, the agent model 302 can take an action aₜ, which can correspond to retrieving a set of content items from different buckets or clusters of content items. The action aₜ can be based on a context comprising the input query and optionally one or more contextual factors. The action space may define (all) the possible actions the agent model 302 can take. In some embodiments, content items may have been divided or grouped into F number of buckets. Each of the F buckets have semantically relevant items for a given query. The action space may include a weight vector of size F (e.g., a vector having F number of weights or weight values), signifying the importance given to each bucket.

Each of the F number of buckets may include top K items that are semantically relevant to the query. In some embodiments, each of the F number of buckets may include top K items that are contextually relevant to the context. Each of the content items may have a semantic relevance/affinity score between 0 and 1, signifying how relevant the content item is to the query. In some embodiments, each of the content items may have a contextual relevance/affinity score between 0 and 1, signifying how relevant the content item is to the context. The action of the agent model 302 may include an F dimensional weight vector [W₁, W₂, . . . , and W_{F}] indicating the scaling of the semantic relevance/affinity score of content items in each of the buckets. The semantic relevance/affinity score of each content item may be scaled by their corresponding buckets weights in the weight vector. For example, for a query “Fishing”, each bucket may have top K semantically relevant items with semantic relevance/affinity scores between 0 and 1. The agent model 302 can take an action and output an action vector, [0.4, 0.2, 0.3, 0.1, 0.7, 0.8, 0.9, 0.2, 0.3, 0.7] (e.g., each element in the action vector corresponds to a bucket). In some embodiments, the action of the agent model 302 may include an F dimensional weight vector [W₁, W₂, . . . , and W_{F}] indicating the scaling of the contextual relevance/affinity score of content items in each of the buckets. The contextual relevance/affinity score of each content item may be scaled by their corresponding buckets weights in the weight vector. For example, for a query “Fishing”, each bucket may have top K contextual relevant items with contextual relevance/affinity scores between 0 and 1. The agent model 302 can take an action and output an action vector, [0.4, 0.2, 0.3, 0.1, 0.7, 0.8, 0.9, 0.2, 0.3, 0.7] (e.g., each element in the action vector corresponds to a bucket).
0.4 may be the weight corresponding to bucket 1.
0.2 may be the weight corresponding to bucket 2.
0.3 may be the weight corresponding to bucket 3.
0.1 may be the weight corresponding to bucket 4.
0.7 may be the weight corresponding to bucket 5.
0.8 may be the weight corresponding to bucket 6.
0.9 may be the weight corresponding to bucket 7.
0.2 may be the weight corresponding to bucket 8.
0.3 may be the weight corresponding to bucket 9.
0.7 may be the weight corresponding to bucket 10.

The agent model 302 can take an action by scaling semantic relevance/affinity scores of content items based on the corresponding bucket weights (e.g., using a weight in the action vector corresponding to the bucket that a content item belongs to). In some embodiments, the agent model 302 can take an action by scaling contextual relevance/affinity scores of content items based on the corresponding bucket weights (e.g., using a weight in the action vector corresponding to the bucket that a content item belongs to).
Semantic (or contextual) relevance/affinity scores of content items in bucket 1 may be scaled by 0.4.
Semantic (or contextual) relevance/affinity scores of content items in bucket 2 may be scaled by 0.2.
Semantic (or contextual) relevance/affinity scores of content items in bucket 3 may be scaled by 0.3.
Semantic (or contextual) relevance/affinity scores of content items in bucket 4 may be scaled by 0.1.
Semantic (or contextual) relevance/affinity scores of content items in bucket 5 may be scaled by 0.7.
Semantic (or contextual) relevance/affinity scores of content items in bucket 6 may be scaled by 0.8.
Semantic (or contextual) relevance/affinity scores of content items in bucket 7 may be scaled by 0.9.
Semantic (or contextual) relevance/affinity scores of content items in bucket 8 may be scaled by 0.2.
Semantic (or contextual) relevance/affinity scores of content items in bucket 9 may be scaled by 0.3.
Semantic (or contextual) relevance/affinity scores of content items in bucket 10 may be scaled by 0.7.

In some cases, the weights in the action vector may have a range of (0 1], e.g., a weight may be greater than 0 (e.g., not equal to zero) and less than or equal to 1.

On taking the action aₜ, the environment 304 (e.g., representative of user simulated behaviors), can yield a corresponding reward Gₜ. Depending on the feedback reward Gₜ received from environment 304, agent model 302 learns (e.g., updates its policy) and can try again, attempting to get better at performing the action aₜ, for a given state sₜ of the environment 304 (e.g., finding better K's for a given context comprising a query and optionally one or more contextual factors).

Reinforcement learning illustrated in FIG. 3A can be implemented using one or more approaches to training agent model 302. For example, agent model 302 can learn through batch reinforcement learning. Agent model 302 can learn from a fixed dataset of actual experiences, in some cases, without interacting with environment 304. In another example, agent model 302 can learn through online reinforcement learning. Agent model 302 can learn from interacting with environment 304 in real time. Agent model 302 may be trained using rewards provided by environment 304. In yet another example, agent model 302 can learn through a combination of batch reinforcement learning and online reinforcement learning.

Reinforcement learning illustrated in FIG. 3A can implement Q-learning. In Q-learning, agent model 302 may learn to output action vectors by maximizing an expected reward of an action vector generated based on a given state.

Reinforcement learning illustrated in FIG. 3A can implement temporal difference learning, which may be particularly useful for optimizing agent model 302 to take actions that are temporal in nature (e.g., completing rounds in an episode to optimize long-term expected rewards). In temporal difference learning, agent model 302 may predict a reward in a next moment in time. When a new reward is observed, the new reward can be compared against the predicted/expected reward. If the two rewards differ, the agent model 302 may use the temporal difference to adjust parameters of agent model 302 to better match the new reward.

Referring to FIG. 3B, the action vector output of the agent model 302 after the agent model 302 learns through reinforcement learning as illustrated in FIG. 3A can be used to determine optimal K's 306 for a given context 280. Context 280 of a user making a query may be used as input to agent model 302. Agent model 302 can produce an action vector based on context 280. The action vector can be used to determine optimal K's 306 used by technique 200 to retrieve content items from F buckets. The context 280 may be provided as input to retrieve content items by technique 200. Optimal K's 306 may be applied to weigh the distribution of retrieved content items across from the F buckets in technique 200. In other words, the optimal K's 306 may determine K's based on context 280, which are used to collate results 206 using appropriate K's for the different buckets. Results 206 may be provided or displayed to the user.

### Exemplary World Parameters of the Environment

As discussed with FIG. 3A, agent model 302 can explore environment 304, and take action to learn how to update the parameters of agent model 302. Agent model 302 can explore the environment 304 in the form of many rounds and episodes and learn from the results of the rounds and episodes. An example of an episode having one or more rounds is shown and described in FIG. 6. Environment 304 may represent real world data and/or simulated data about queries and content items. In some embodiments, environment 304 may represent real world data and/or simulated data about contexts and content items. Environment 304 may include one or more world parameters 402, e.g., variables that define a round (e.g., a simulated version of environment 304). Agent model 302, when exploring environment 304 in a round, can sample from the one or more world parameters 402 to simulate content item retrieval and take an action on the content items retrieved. Agent model 302, when exploring environment 304, can follow one or more rules, e.g., dynamics defining how the variables interact, to carry out one or more rounds to complete an episode. Following the one or more rules over multiple rounds in an episode, agent model 302 can simulate long-term user interaction in content item retrieval when exploring environment 304. Results of rounds and episodes may be observed and used to update parameters of agent model 302.

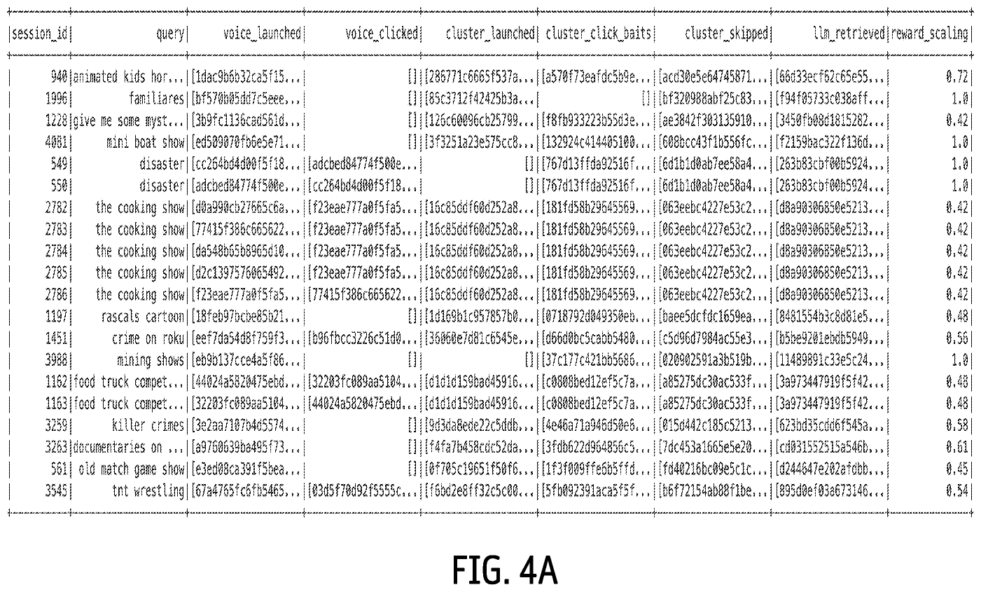

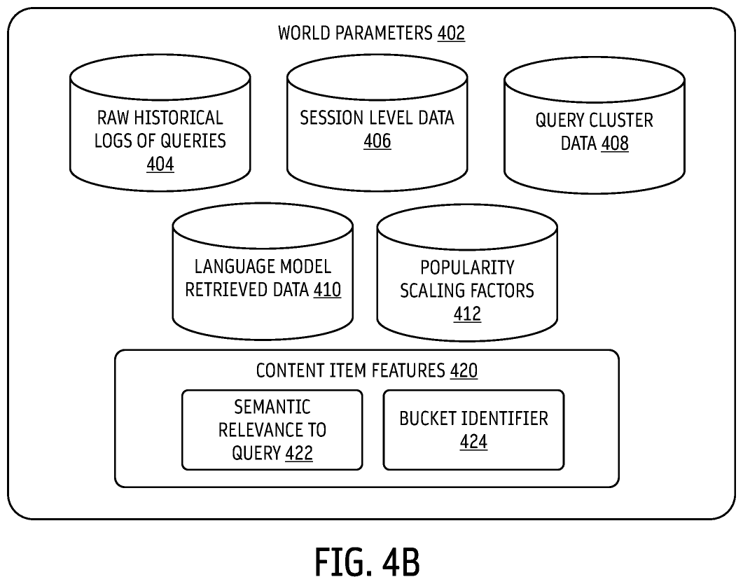

FIG. 4A illustrates an exemplary excerpt of world parameters, according to some embodiments of the disclosure. FIG. 4B illustrates exemplary world parameters 402, according to some embodiments of the disclosure. World parameters 402 may include one or more of: raw historical logs of queries 404, session-level data 406, query cluster data 408, and language model retrieved data 410. World parameters 402 may include popularity scaling factors 412. World parameters 402 may include one or more content item features 420, e.g., semantic relevance/affinity to a given query 422, and bucket identifier 424. World parameters 402 may offer a diverse or balanced representation of an environment from which simulated environments can be pulled.

Raw historical logs of queries 404 that (real world) users have made on a content retrieval system (e.g., a search and recommendation system) may include raw data of queries made by users on the content retrieval system, content items which were shown to a user in a given session for a query, content item(s) which were clicked, and content item(s) which were launched. Raw historical logs of queries 404 may include session identifiers, timestamps, device identifiers, profile identifiers, query made, whether a content item shown was focused, whether a content item shown was clicked on, whether a content item shown was launched, whether a content item was shown but never focused, clicked on, or launched, streaming duration for a content item, to which bucket a content item belongs, etc. In some cases, raw historical logs of queries 404 includes contextual factor(s) that accompanied the queries made by users. Raw historical logs of queries 404 may be replaced by and/or supplemented with raw historical logs of contexts that includes contexts that (real world) users have provided as input on a content retrieval system. Raw historical logs of contexts can include raw data of queries made by users on the content retrieval system, one or more contextual factors, content items which were shown to a user in a given session for the context, content item(s) which were clicked, and content item(s) which were launched, etc. Raw historical logs of contexts may include session identifiers, timestamps, device identifiers, profile identifiers, query made, one or more contextual factors, whether a content item shown was focused, whether a content item shown was clicked on, whether a content item shown was launched, whether a content item was shown but never focused, clicked on, or launched, streaming duration for a content item, to which bucket a content item belongs, etc.

Session-level data 406 may be derived from raw historical logs of queries 404. Session-level data 406 may provide user-level or session-level representation of the environment. Session-level data 406 may include many log entries or rows. Session-level data 406 may include user distinct session-level data. Session-level data 406 may include queries made on the content item retrieval system and interaction data with content items (e.g., whether a content item was clicked, launched, or skipped for a given query). A log entry or row in session-level data 406 may include a session identifier (“session_id” in FIG. 4A) that identifies a user session on the content item retrieval system in which a query was made. The log entry or row in session-level data 406 may include a query (“query” in FIG. 4A, e.g., a string value) that identifies the free language query that a user made on the content item retrieval system in the session. The log entry or row in session-level data 406 may include one or more launched content item identifiers (“voice_launched” in FIG. 4A, e.g., an array of one or more content item identifiers) specifying one or more content items that were launched in the session for the query. The log entry or row in session-level data 406 may include one or more clicked content item identifiers (voice_clicked in FIG. 4A, e.g., an array of one or more content item identifiers) specifying one or more content items that were clicked in the session for the query. A content item in the one or more launched content item identifiers may not be double counted in the one or more clicked content item identifiers for a given session. A content item may be in the one or more clicked content item identifiers and not in the one or more launched content item identifiers if the content item was clicked but not launched in the given session. In some embodiments, session-level data 406 may be derived from raw historical logs of contexts. The log entry or row in session-level data 406 may include one or more contextual factors.

Query cluster data 408 may be derived from raw historical logs of queries 404. Similar or same queries that are semantically similar or same can be grouped into query clusters to group data to provide an aggregate-level representation of the environment. For example, a query “show me western movies”, a query “western movies”, and a query “play western movies” can be grouped or clustered together. Queries in raw historical logs of queries 404 may be analyzed to determine query clusters having semantically similar or same queries. A log entry or row in query cluster data 408 may include one or more launched content items (cluster_launched in FIG. 4A, e.g., an array of one or more content item identifiers) specifying one or more content items that were launched for the query cluster. A log entry or row in query cluster data 408 may include one or more click-bait content items (“cluster_click_baits” in FIG. 4A, e.g., an array of one or more content item identifiers) specifying one or more content items that were clicked but not launched for the query cluster. A log entry or row in query cluster data 408 may include one or more skipped content items (“cluster_skipped” in FIG. 4A, e.g., an array of one or more content item identifiers) specifying one or more content items that were shown to users but not clicked nor launched for the query cluster. One or more skipped content items may represent true negatives because users never engaged with the items for a given query or query cluster. In some cases, query cluster data 408 may be replaced by and/or supplemented with context cluster data. Similar or same contexts may be grouped into context clusters to group data to provide an aggregate-level representation of the environment.

Language model retrieved data 410 may include data that is generated using one or more semantic language models or one or more large language models. An entry or row in language model retrieved data 410 may include a query (“query” in FIG. 4A, e.g., a string value). An entry or row may include one or more model retrieved content items (“llm_retrieved” in FIG. 4A, e.g., an array of one or more content item identifiers) specifying one or more content items that were retrieved by the language model for the specific query. Using the language model, the specific query may be transformed into a query embedding and content items may be transformed into content item features. Dot product of the query embedding and individual content item features may be computed. An H number of content items that yielded the highest dot product results may be retrieved by the language model for the specific query. The content item may be stored or encoded as the one or more model retrieved content items. Language model retrieved data 410 may represent the environment with semantically relevant data and may not account for popularity or historical past user interactions. In some embodiments, language model retrieved data 410 may include data that is generated using one or more models (which may include an a language model or semantic-based model). An entry or row in language model retrieved data 410 may include a context (comprising a query and optionally one or more contextual factors). An entry or row may include one or more model retrieved content items (e.g., an array of one or more content item identifiers) specifying one or more content items that were retrieved by a model for the specific context. Using the model, the specific context may be transformed into a context embedding and content items may be transformed into content item features. Dot product of the context embedding and individual content item features may be computed. An H number of content items that yielded the highest dot product results may be retrieved by the model for the specific context. The content item may be stored or encoded as the one or more model retrieved content items.

Popularity scaling factors 412 may include popularity scaling factors or scaling scores for queries. In some embodiments, popularity scaling factors 412 may include popularity scaling factors or scaling scores for contexts. An entry or row in popularity scaling factors 412 may include a query (query in FIG. 4A, e.g., a string value), or query cluster. An entry or row in popularity scaling factors 412 may include a popularity scaling factor or scaling score (“scaling” in FIG. 4A, e.g., a number between 0 and 1) for the query or query cluster. In some embodiments, an entry or row in popularity scaling factors 412 may include a context (comprising a query and one or more optional contextual factors), or context cluster. An entry or row in popularity scaling factors 412 may include a popularity scaling factor or scaling score (e.g., a number between 0 and 1) for the context or context cluster. Popular queries may have a higher proportion of log entries or rows in world parameters. Having a higher proportion of log entries or rows may cause the agent model to overfit to popular queries. The popularity scaling factor or score may have an inverse relationship with popularity of a query or query cluster. If a query cluster has a large size, e.g., a large number of distinct queries, the sessions and episodes drawing content items corresponding to the query cluster may be skewed to the query cluster. For example, the popularity scaling factor or score may be an inverse log of query cluster size (e.g., scaling=1/log (cluster_size)). The popularity scaling factor or score can penalize and/or regularize query clusters that have many distinct queries and scale down the impact of popular queries on the agent model's learning. In some embodiments, popular contexts may have a higher proportion of log entries or rows in world parameters. Having a higher proportion of log entries or rows may cause the agent model to overfit to popular contexts. The popularity scaling factor or score may have an inverse relationship with popularity of a context or context cluster. If a context cluster has a large size, e.g., a large number of distinct contexts, the sessions and episodes drawing content items corresponding to the context cluster may be skewed to the context cluster. For example, the popularity scaling factor or score may be an inverse log of context cluster size (e.g., scaling=1/log (cluster_size)). The popularity scaling factor or score can penalize and/or regularize context clusters that have many distinct contexts and scale down the impact of popular contexts on the agent model's learning. In some embodiments, popularity scaling factors 412 may be supplemented with and/or replaced by other types of scaling factors. For example, scaling factors that depend on revenue generation of the query/context, or query/context cluster can be included to encourage the agent model's learning to produce action vectors that increases revenue generation. In another example, scaling factors can depend on a characteristic of the user that interacted with the content item. An example of the characteristic can depend on whether the user is an expert user or not.

When an agent plays a round, content items that are sampled from the environment for the round may have content item features 420. One example of a content item feature is the semantic relevance/affinity to a given query 422. Semantic relevance/affinity may be determined based on a dot product between a query embedding of the given query using a language model and content item features extracted from data about the content item (e.g., metadata) using the language model. Semantic relevance/affinity (score) may measure the semantic relevance of a content item to a given query. In some cases, the semantic relevance/affinity to a given query 422 may be replaced by and/or supplemented with contextual relevance/affinity to a given context comprising a query and one or more contextual factors. Contextual relevance/affinity may be determined based on a dot product between a contextual embedding of the given context using a model and content item features extracted from data about the content item (e.g., metadata) using the model. Contextual relevance/affinity (score) may measure the contextual relevance of a content item to a given context. Another example of a content item feature is bucket identifier 424, which may be based on which bucket the content item belongs to (e.g., f=1, 2, . . . . F). As discussed with FIG. 1, content items may be divided into F number of buckets.

Semantic relevance scores can be determined by determining a first feature vector representing the query (e.g., using a semantic model), determining second feature vectors representing metadata of the sampled content items respectively; and determining a dot product of the first feature vector and each one of the second feature vectors. The semantic relevance scores are based on the dot products, which can measure how relevant a sampled content item is to the query. In some embodiments, contextual relevance scores can be determined by determining a first feature vector representing the context (e.g., using one or more models), determining second feature vectors representing metadata of the sampled content items respectively; and determining a dot product of the first feature vector and each one of the second feature vectors. The first feature vector may include multiple feature vectors, generated by multiple models, representing the query of the context and one or more contextual factors of the context. The contextual relevance scores are based on the dot products, which can measure how relevant a sampled content item is to the context.

### Exemplary Agent Model Flow

In reinforcement learning, an agent model explores the environment to learn from the exploration and observations made from the exploration. The agent model may play one or more rounds in an episode. An example of an episode having one or more rounds is shown and described in FIG. 6. Round-level reward can be determined for each round. The agent model may complete one or more episodes. Long-term reward can be determined for each round based on the round-level reward of the present round and one or more future rounds in a given episode.

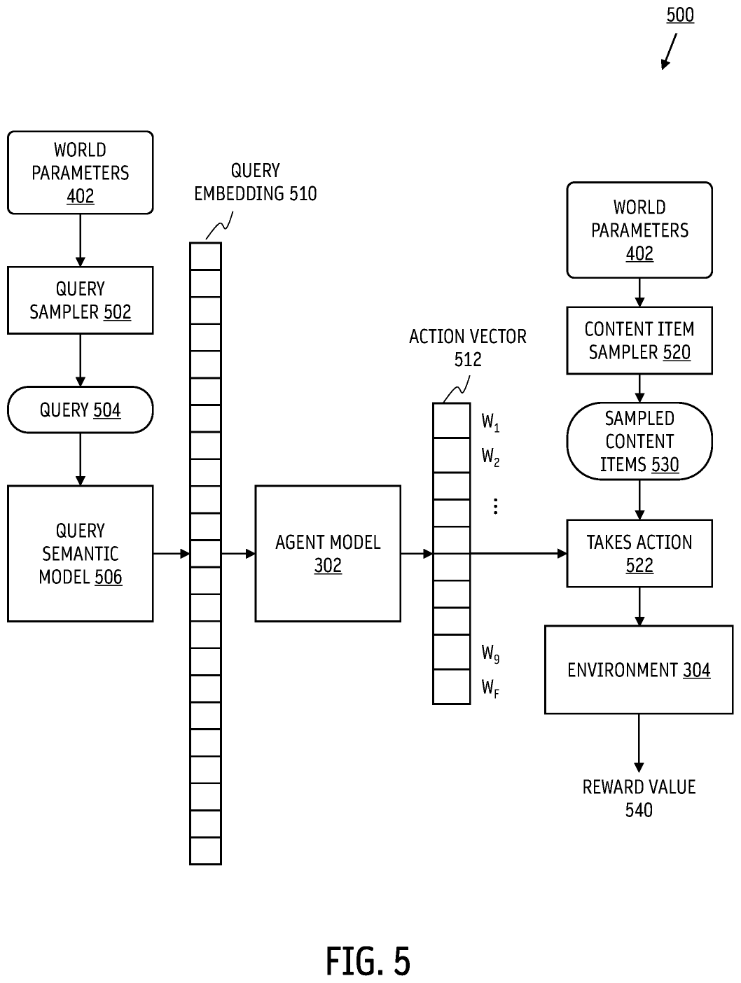

FIG. 5 illustrates exemplary agent model flow 500, according to some embodiments of the disclosure. Exemplary agent model flow 500 illustrates query sampling and content item sampling in a round. Exemplary agent model flow 500 illustrates agent model 302 taking an action in the round. Query sampler 502 may randomly sample or select query 504 from world parameters 402. The query 504 may be the basis of a round, simulating a random query being made by a simulated user. Content item sampler 520 may randomly sample or select a set of T number of sampled content items 530 from world parameters 402 that are associated with query 504. Specifically, the T number of sampled content items 530 may include a P number of positive content items and an N number of negative content items. T=P+N. T equals to a sum of P and N. P and N may be fixed for all rounds being played by the agent model 302. A ratio of P:N may be 1:3. A ratio of P:N may be 1:4. Preferably, N is greater than P. P may be 5, and N may be 15. Having more negative content items than positive items may improve the agent model's ability to learn from the result of taking an action in a round. The T number of sampled content items 530 may be presented to agent model 302.

In some embodiments, exemplary agent model flow 500 may include context sampling and content item sampling in a round. Query sampler 502 may be replaced by and/or supplemented with a context sampler to randomly sample or select a context from world parameters 402. The context sample by the context sampler may be the basis of a round, simulating a random context input by a simulated user. The context may include a query and one or more contextual factors. Content item sampler 520 may randomly sample or select a set of T number of sampled content items 530 from world parameters 402 that are associated with the context.

Sampled positive content items may include a mix of P number of content items randomly sampled from voice_launched, voice_clicked, cluster_launched, and llm_retrieved as illustrated in FIGS. 4A-B. P number of positive content items may include A number of voice_launched content item(s), B number of voice_clicked content item(s), C number of cluster_launched content item(s), and D number of llm_retrieved content item(s). P=A+B+C+D.

Sampled negative content items may include a mix of N number of content items randomly sampled from cluster_skipped and cluster_click_baits as illustrated in FIGS. 4A-B. N number of negative content items may include E number of cluster_skipped content item(s), and F number of cluster_click_baits content item(s). N=E+F.

Sampled content items 530 may each have a corresponding reward value. A reward value may indicate a learning value or weight for a given content item, or indicate how strong a signal given by a content item is when the agent model 302 learns from the round. Reward value for different types of content items in world parameters may be different. Positive content items may have a positive reward value. Negative content items may have a negative reward value. Absolute values of reward or learning values of different content items may differ based on the strength of the signal given by the content item. Exemplary reward values for content items are as follows:
Reward value for voice_launched=+100.
Reward value for voice_clicked=+50
Reward value for cluster_launched=+30
Reward value llm_retrieved=+1
Reward value for cluster_skipped=−50
Reward value for cluster_click_baits=−40

In some embodiments, the corresponding reward values of sampled content items 530 may be multiplied and/or scaled by the popularity scaling factor (e.g., scaling in FIG. 4A, and popularity scaling factor 412 of FIG. 4B). In some embodiments, the corresponding reward values of sampled content items 530 may be multiplied and/or scaled by a suitable scaling factor (e.g., scaling factor based on revenue generation, scaling factor based on a characteristic of the user that interacted with the content item, scaling factor based on a characteristic of the query/context, etc.). Exemplary scaled reward values for content items are as follows:
Reward value for voice_launched=+100*scaling (in some cases, the popularity scaling factor is not applied to session-level data)
Reward value for voice_clicked=+50*scaling (in some cases, the popularity scaling factor is not applied to session-level data)
Reward value for cluster_launched=+30*scaling
Reward value llm_retrieved=+1*scaling (in some cases, the popularity scaling factor is not applied to language model retrieved data)
Reward value for cluster_skipped=−50*scaling
Reward value for cluster_click_baits=−40*scaling

In some cases, the popularity scaling factor and/or other suitable scaling factors are provided for different queries or contexts. The scaling factor may be applied to the corresponding reward values of sampled content items 530 individually. In some cases, the scaling factor may be applied to a sum of reward values, e.g., after the agent model 302 takes action 522.

In the round, query 504 is input into a query semantic model 506. A query semantic model may transform query 504 into a query embedding 510 (e.g., a query state). Query embedding 510 may be input into agent model 302. Agent model 302 may output an action vector 512. An action vector may include one or more weights corresponding to F different buckets (e.g., F number of buckets discussed in FIGS. 1-3), shown as W₁, W₂, . . . , and W_{F}. The one or more weights may be used to determine K's to be used in retrieving content items from the F different buckets (as illustrated in FIGS. 2-3).

In some embodiments, a context (comprising query 504 and optionally one or more contextual factors) is input into one or more models to produce a context embedding (e.g., a context state). The context embedding may include a family of feature embeddings that correspond to the query and one or more contextual factors in the context. Context embedding may be input into agent model 302.

Agent model 302 may take an action 522 on sampled content items 530 using the action vector 512. Agent model 302 may determine from environment 304 content item features such as semantic affinity/relevance scores (measuring semantic affinity of a sampled content item to query 504) and bucket identifiers (specifying which bucket a sampled content item belongs to) for the sampled content items 530. Agent model 302 may scale or multiply a semantic relevance/affinity score for each content item in sampled content item 530 with the weight corresponding to the bucket that the content item belongs to (e.g., according to the weights in action vector 512). Agent model 302 may determine scaled semantic affinity/relevance scores for the sample content items 530 (scaled based on the action vector 512). Agent model 302 may arrange the sampled content items 530 based on the scaled semantic affinity/relevance scores (e.g., from high to low).

In some embodiments, agent model 302 may determine from environment 304 content item features such as contextual relevant/affinity scores (measuring contextual affinity of a sampled content item to a context) and bucket identifiers (specifying which bucket a sampled content item belongs to) for the sampled content items 530. Agent model 302 may scale or multiply a contextual relevance/affinity score for each content item in sampled content item 530 with the weight corresponding to the bucket that the content item belongs to (e.g., according to the weights in action vector 512). Agent model 302 may determine scaled contextual affinity/relevance scores for the sample content items 530 (scaled based on the action vector 512). Agent model 302 may arrange the sampled content items 530 based on the scaled contextual affinity/relevance scores (e.g., from high to low).

Agent model 302 may determine and/or compute a round-level reward value 540 based on reward values (scaled according to the action vector 512) corresponding to top R number of sampled content items 530 having high scaled semantic affinity/relevance scores. In some embodiments, agent model 302 may determine and/or compute a round-level reward value 540 based on reward values (scaled according to the action vector 512) corresponding to top R number of sampled content items 530 having high scaled contextual affinity/relevance scores. In some embodiments, agent model 302 may sum reward values (scaled according to the action vector 512) of the top R number of content items and use the sum as the round-level reward value 540 of the round. R may be 5. R may depend on a number of content items having reward values (scaled according to the action vector 512) being above a threshold.

In some embodiments, round-level reward value 540 of FIG. 5 may be determined or modeled based on other factors.

In some cases, the round-level reward value 540 may include a sum of reward values (scaled according to the action vector 512) for the top R number of sampled content items having highest semantic affinity/relevance scores. In some embodiments, the round-level reward value may include a sum of reward values (scaled according to the action vector 512) for the top R number of sampled content items having highest contextual affinity/relevance scores. The agent model may try to converge to a generic model that maximizes the round-level reward value across multiple rounds.

In some cases, the round-level reward value 540 may include a binary flag of positive round reward or negative round reward (e.g., whether the sum of (scaled) reward values for the top R number of sampled content items is positive or negative). The round-level reward value may not capture a magnitude of the reward for the round but captures whether the reward is positive or negative. The agent model may have suboptimal convergence when the agent model is not maximizing the number of positive content items in the top R number of sampled content items.

In some cases, the round-level reward value 540 may include the value of the trust parameter value at the end of the round (e.g., an updated value of the trust parameter of the episode after completing a round). The value may be a proxy for the reward of the round. The agent model may optimize to maximize the trust parameter at the end of each round, which may converge to find actions that increases user engagement and user satisfaction. Details about the trust parameter are described with FIG. 6.

In some embodiments, round-level reward value 540 may include regret value, which measures what a particular round could have gotten as the maximum (possible) reward value. Regret value may be the maximum reward value of the round subtracted by the reward value of the round (e.g., calculated based on one or more of precision, recall, discounted cumulative gain, mean reciprocal rank, etc.). Computing regret may include subtracting a maximum possible reward value of the top R number of content items having the highest reward values (scaled according to the action vector 512) by a reward value of the top R number of content items having the highest reward values (scaled according to the action vector 512).

In some embodiments, the round-level reward value may be scaled based on the popularity scaling factor and/or other suitable scaling factors are provided for different queries or contexts.

In some embodiments, round-level reward value 540 may include a suitable combination of metrics, such as the metrics mentioned above (sum of reward values of top R items, binary flag, trust parameter, regret value), revenue generation potential, seasonality, popularity, precision, recall, discounted cumulative gain, mean reciprocal rank, etc. The combination of metrics may be a weighted combination or sum. The combination of metrics may be generated based on a (linear or non-linear) function of the metrics. Round-level reward value 540 may impact how the agent model learns from completing the round, and can be biased based on a combination of metrics desirable for the application.

Dynamics: Playing Rounds and Completing Episodes while Following One or More Rules

Besides playing a round, the agent model 302 as seen in the FIGS. explores and learns from long-term engagement in the environment 304 as seen in the FIGS. by playing one or more rounds to complete an episode. The simulated user for a given episode has a trust parameter. The trust parameter may determine whether the simulated user would come back to play more rounds. An episode may have a maximum number of rounds allowed in a single episode. The maximum number of rounds may be 20 rounds in an episode. The maximum number of rounds may be a hyperparameter.

The trust parameter may be in the form of a (complex) utility function. A utility function may quantify trust, value, satisfaction to the simulated user based on the results of a round (e.g., including reward values or scaled reward values of the content items in a round). A utility function may include one or more variables defined based on the results of a round. One example of a utility function may account for the quantity of content items in the top K content times in the round with positive reward values. A utility function may account for the (scaled) reward values associated with in the top K content times in the round. The trust parameter may be a (slow) moving average.

The trust parameter may be initialized at an initial value at a beginning of an episode, e.g., a first round in an episode. The trust parameter may be updated at the end of each round based on the results of the round, e.g., round-level reward value 540 of FIG. 5. The trust parameter may be updated based on the current value for the trust parameter and the results of the round. The trust parameter may be updated based on a timing constant or a decay factor). The trust parameter of the episode may be updated based on the round-level reward value and a function.

The trust parameter may increase in value if the results of the round is positive, e.g., if round-level reward value 540 of FIG. 5 is positive (indicating the action performed well, yielding content items which are engaging or have positive reward values), or is greater than a threshold. An increase in value for the trust parameter may indicate the user is gaining trust and/or is satisfied by the action taken in the round.

The trust parameter may decrease in value if the results of the round is negative, e.g., if round-level reward value 540 of FIG. 5 is negative (indicating the action performed poorly, yielding content items which are not engaging and have negative reward values), or is less than a threshold. A decrease in value for the trust parameter may indicate the user is losing trust and/or is not satisfied by the action taken in the round.

Updating the value of the trust parameter at the end of a round at t having a round_reward_valueₜ and a present value for the trust parameter trustₜ can be performed as follows to obtain the updated value for the trust parameter, trustₜ₊₁:

trustₜ₊₁=decay_factor*round_reward_valueₜ+(1−decay_factor)*trustₜ

If a value of the trust parameter falls below a threshold, no further rounds are played in an episode. The episode ends. If the number of rounds played in an episode hits the maximum number of rounds, no further rounds are played in the episode. The episode ends.

In some embodiments, the trust parameter can be produced by a model, such as an artificial neural network. The round reward value and/or past round reward values can be provided as input to the model to determine the trust parameter, which may represent a likelihood of a user returning to the content item retrieval system or platform. In some cases, the model may receive information about the top R content items presented in the round and the query/context of the round.

In some embodiments, the trust parameter is updated based on the reward of a completed round. In response to the trust parameter meeting a criterion and a number of rounds completed in an episode has not reached a maximum number, a further query/context can be obtained to complete a further round of the episode. In response to the trust parameter not meeting a criterion and the number of rounds completed in an episode has not reached the maximum number, the episode can be ended. In response to the number of rounds completed in an episode has reached the maximum number, the episode can be ended. The dynamics of an episode can impact how long-term rewards are calculated. Using a trust parameter as one way to end an episode can simulate situations where trust with a user being increased or decreased over time.

FIG. 6 illustrates an exemplary episode 600 having one or more rounds, according to some embodiments of the disclosure.

An episode 600 may begin in 604 involving the agent model playing a first round. A current round number (round #) of episode 600 may be initialized at 1. Value for the trust parameter may be initialized at an initial value.

At the end of the round at 606, the trust parameter may be updated and/or determined based on the results of the round (e.g., round-level reward value).

Check 608 may determine whether the trust parameter is greater than a threshold (or is positive). If no, the episode 600 ends in 614. In some embodiments, check 608 may utilize a different metric to determine whether the episode 600 should continue. For example, check 608 may determine whether the trust parameter is increasing or decreasing. If increasing, check 608 may disallow episode 600 to continue. If decreasing, check 608 may allow the episode 600 to continue. In some cases, check 608 may determine whether the trust parameter is increasing, decreasing, or staying the same. If increasing or staying the same, check 608 may allow the episode 600 to continue. If decreasing, check 608 may disallow the episode 600 to continue.

If yes, check 610 may determine whether the current round number (round #) is less than or equal to a maximum number of rounds allowed in episode 600 (max round #). If no, the episode 600 ends in 614.

If yes, the current round number may increment by 1 in 612. The next round can be played in 604.

Check 608 and check 610 may be performed in any order. If either check 608 or check 610 results in no, episode 600 ends in 614.

### Exemplary Method for Playing a Round in an Episode

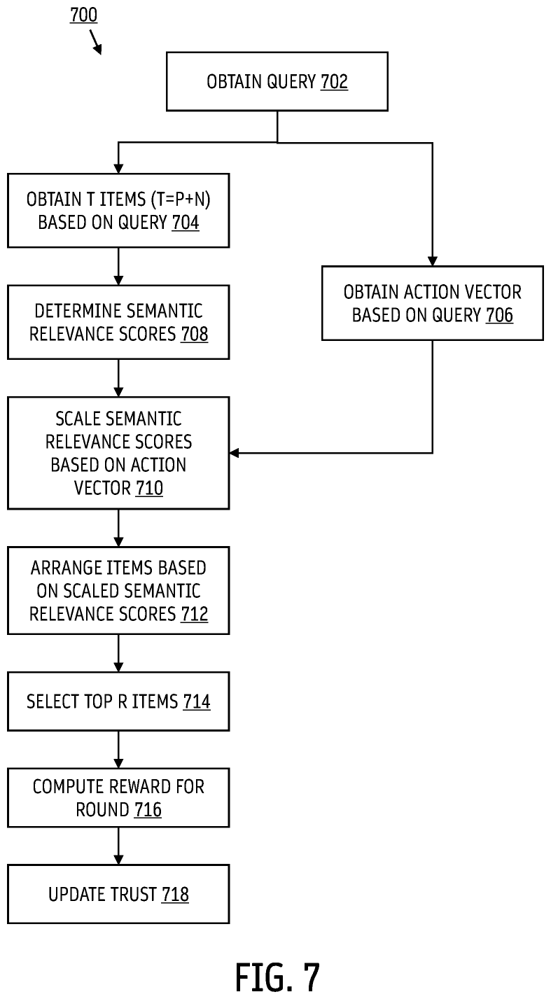

FIG. 7 is a flow chart illustrating operations (of method 700) performed in a round of an episode, according to some embodiments of the disclosure.

In 702, a query may be obtained (e.g., randomly sampled as illustrated in FIG. 5). In some embodiments, a context may be obtained (e.g., randomly sampled as illustrated in FIG. 5).

In 706, an action vector may be obtained using the agent model based on the query obtained in 702. In some embodiments, an action vector may be obtained using the agent model based on the context obtained in 702.

In 704, T number of content items may be obtained (e.g., randomly sampled as illustrated in FIG. 5).

In 708, the semantic relevance scores may be determined for the content items (e.g., from the environment). In some embodiments, the contextual relevance scores may be determined for the content items (e.g., from the environment).

In 710, the semantic relevance/affinity scores of the content items may be scaled based on the action vector in 706. In some embodiments, the contextual relevance/affinity scores of the content items may be scaled based on the action vector in 706.

In 712, the content items may be arranged (e.g., sorted) based on the scaled semantic relevance/affinity scores of the content items. In some embodiments, the content items may be arranged (e.g., sorted) based on the scaled contextual relevance/affinity scores of the content items.

In 714, top R items may be selected from the arranged content items (e.g., top R items having the highest scaled semantic relevance/affinity scores, top R items having the highest scaled contextual relevance/affinity scores).

In 716, a reward value for the round can be computed based on the reward values corresponding to the top R items in 714.

In 718, the trust parameter may be updated based on the reward value for the round.

Depending on the number of rounds already played in an episode, the operations of method 700 may be repeated for one or more additional rounds in an episode. Depending on the trust parameter value in 718, the operations of method 700 may be repeated for one or more additional rounds in an episode.

### Exemplary Methods for Implementing the Agent Model

In some embodiments, the agent model may include a (deep) neural network comprising two or more neural network layers. A neural network layer may include neurons. A neuron may receive one or more inputs and implement an activation function on the inputs to generate one or more outputs. Parameters of the activation function of the neurons may be trained, learned, or updated based on observations that the agent model has made. The parameters may correspond to the policy or strategy being used by the agent model to produce the action vector.

The observations may include round-level reward values of the rounds played by the agent model. The observations may include expected long-term reward values of the rounds played by the agent model. The parameters may be updated to optimize and/or maximize the reward values. The parameters may be updated using soft actor critic (SAC).

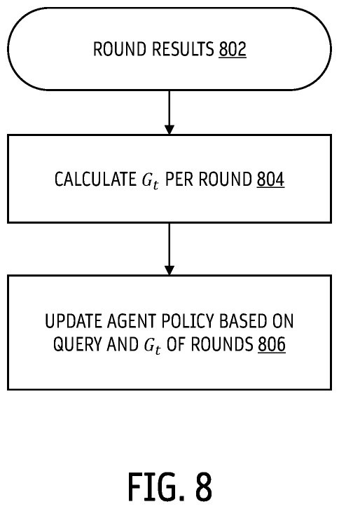

FIG. 8 is a flowchart illustrating operations for training and/or updating an agent model using round results, according to some embodiments of the disclosure. Round results 802 may be collected for many rounds and many episodes. A result of a round may include the query in the round, the action vector generated for the query in the round, the reward value for the round. In some embodiments, a result of a round may include the context in the round, the action vector generated for the context in the round, the reward value for the round.

In 804, a round-level reward rₜ and/or expected long-term rewards Gₜ may be computed, based on the reward value for the present round and one or more future/subsequent rounds of a given episode.

In 806, a policy (e.g., strategy, parameters) of the agent model may be updated based on the query and round-level reward rₜ and/or the expected long-term rewards Gₜ of the rounds. In some embodiments, a policy (e.g., strategy, parameters) of the agent model may be updated based on the context and round-level reward rₜ and/or the expected long-term rewards Gₜ of the rounds.

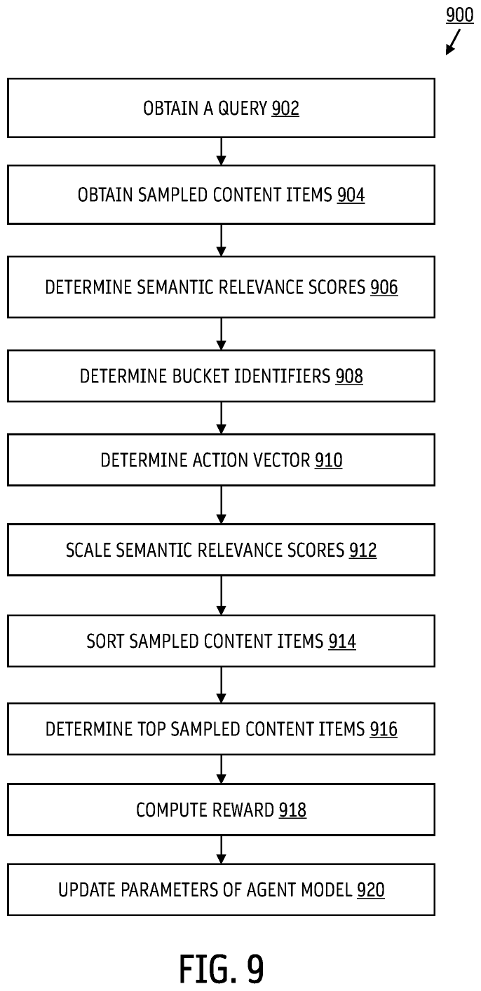

FIG. 9 is a flowchart showing method 900 for training and/or updating parameters of an agent model, according to some embodiments of the disclosure.

In 902, a query may be obtained (e.g., randomly selected from the environment or world parameters). In some embodiments, a context may be obtained (e.g., randomly selected from the environment or world parameters).

In 904, a number of sampled content items may be obtained (e.g., randomly selected from selected from the environment or world parameters) from content items corresponding to the query. In some embodiments, a number of sampled content items may be obtained (e.g., randomly selected from selected from the environment or world parameters) from content items corresponding to the context. The sampled content items may include positive content items and negative content items.

In 906, semantic relevance scores corresponding to the sampled content items, may be determined. A semantic relevance score can measure semantic affinity of a content item to the query. In some embodiments, contextual relevance scores corresponding to the sampled content items, may be determined. A contextual relevance score can measure contextual affinity of a content item to the context.

In 908, bucket identifiers corresponding to the sampled content items may be determined (e.g., identifying which bucket a content item belongs to).

In 910, using parameters of an agent model and an embedding of the query, an action vector comprising weights corresponding to different bucket identifiers may be determined. In some embodiments, using parameters of an agent model and an embedding of the context, an action vector comprising weights corresponding to different bucket identifiers may be determined.

In 912, for each sampled content item, the semantic relevance score may be scaled based on the bucket identifier of the sampled content item and a weight in the action vector corresponding to the bucket identifier of the sampled content item. In some embodiments, for each sampled content item, the contextual relevance score may be scaled based on the bucket identifier of the sampled content item and a weight in the action vector corresponding to the bucket identifier of the sampled content item.

In 914, the sampled content items may be sorted based on scaled semantic relevance scores. In some embodiments, the sampled content items may be sorted based on scaled contextual relevance scores.

In 916, a top number of content items having scaled semantic relevance scores may be determined. In some embodiments, a top number of content items having scaled contextual relevance scores may be determined.

In 918, a reward may be computed based on reward values corresponding to a top number of sampled content items having highest scaled semantic relevance scores. In some cases, the reward may be computed based on a trust parameter value updated based on the reward values of the top number of sampled content items having highest scaled semantic relevance scores. In some embodiments, a reward may be computed based on reward values corresponding to a top number of sampled content items having highest scaled contextual relevance scores. In some cases, the reward may be computed based on a trust parameter value updated based on the reward values of the top number of sampled content items having highest scaled contextual relevance scores.

In 920, the parameters of the agent model may be updated based on the query, the action vector, and the reward. In some embodiments, the parameters of the agent model may be updated based on the query, the action vector, and the reward.

### Exemplary Computing Device

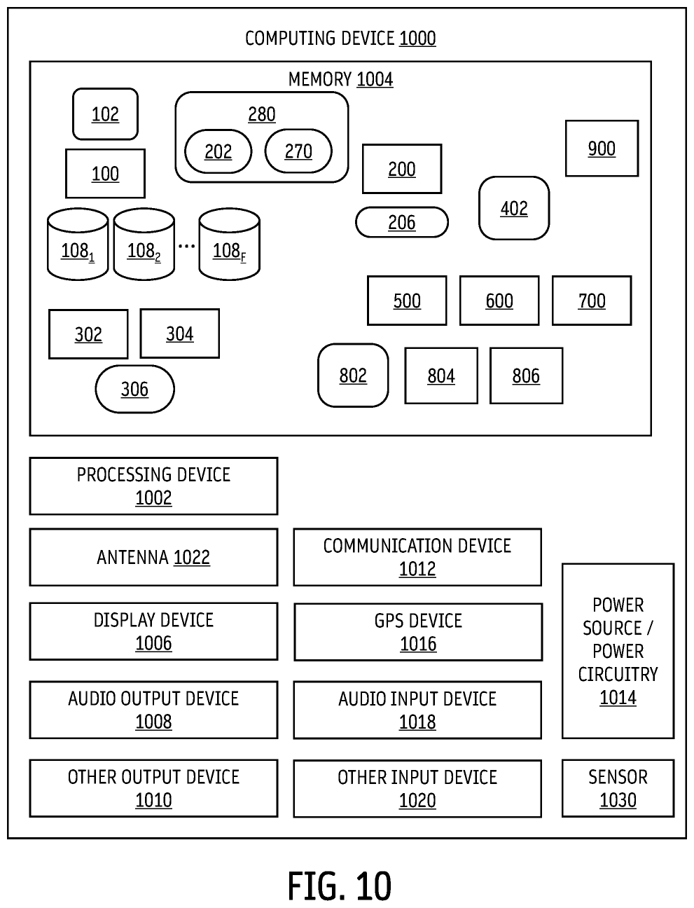

FIG. 10 is a block diagram of an exemplary computing device 1000, according to some embodiments of the disclosure. One or more computing devices 1000 may be used to implement the functionalities described with the FIGS. and herein. A number of components are illustrated in the FIGS. as included in the computing device 1000, but any one or more of these components may be omitted or duplicated, as suitable for the application. In some embodiments, some or all of the components included in the computing device 1000 may be attached to one or more motherboards. In some embodiments, some or all of these components are fabricated onto a single system on a chip (SoC) die. Additionally, in various embodiments, the computing device 1000 may not include one or more of the components illustrated in FIG. 10, and the computing device 1000 may include interface circuitry for coupling to the one or more components. For example, the computing device 1000 may not include a display device 1006, and may include display device interface circuitry (e.g., a connector and driver circuitry) to which a display device 1006 may be coupled. In another set of examples, the computing device 1000 may not include an audio input device 1018 or an audio output device 1008 and may include audio input or output device interface circuitry (e.g., connectors and supporting circuitry) to which an audio input device 1018 or audio output device 1008 may be coupled.

The computing device 1000 may include a processing device 1002 (e.g., one or more processing devices, one or more of the same type of processing device, one or more of different types of processing device). The processing device 1002 may include electronic circuitry that process electronic data from data storage elements (e.g., registers, memory, resistors, capacitors, quantum bit cells) to transform that electronic data into other electronic data that may be stored in registers and/or memory. Examples of processing device 1002 may include a central processing unit (CPU), a graphical processing unit (GPU), a quantum processor, a machine learning processor, an artificial-intelligence processor, a neural network processor, an artificial-intelligence accelerator, an application specific integrated circuit (ASIC), an analog signal processor, an analog computer, a microprocessor, a digital signal processor, a field programmable gate array (FPGA), a tensor processing unit (TPU), a data processing unit (DPU), etc.

The computing device 1000 may include a memory 1004, which may itself include one or more memory devices such as volatile memory (e.g., DRAM), nonvolatile memory (e.g., read-only memory (ROM)), high bandwidth memory (HBM), flash memory, solid state memory, and/or a hard drive. Memory 1004 includes one or more non-transitory computer-readable storage media. In some embodiments, memory 1004 may include memory that shares a die with the processing device 1002. In some embodiments, memory 1004 includes one or more non-transitory computer-readable media storing instructions executable to perform operations described with the FIGS. and herein, such as the methods illustrated in FIGS. 1-3A-B, and 5-9. Exemplary parts that may be encoded as instructions and stored in memory 1004 are depicted. Memory 1004 may store instructions that encode one or more exemplary parts. The instructions stored in the one or more non-transitory computer-readable media may be executed by processing device 1002. In some embodiments, memory 1004 may store data, e.g., data structures, binary data, bits, metadata, files, blobs, etc., as described with the FIGS. and herein. Exemplary data that may be stored in memory 1004 are depicted. Memory 1004 may store one or more data as depicted.

In some embodiments, the computing device 1000 may include a communication device 1012 (e.g., one or more communication devices). For example, the communication device 1012 may be configured for managing wired and/or wireless communications for the transfer of data to and from the computing device 1000. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. The communication device 1012 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication device 1012 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication device 1012 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication device 1012 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication device 1012 may operate in accordance with other wireless protocols in other embodiments. The computing device 1000 may include an antenna 1022 to facilitate wireless communications and/or to receive other wireless communications (such as radio frequency transmissions). The computing device 1000 may include receiver circuits and/or transmitter circuits. In some embodiments, the communication device 1012 may manage wired communications, such as electrical, optical, or any other suitable communication protocols (e.g., the Ethernet). As noted above, the communication device 1012 may include multiple communication chips. For instance, a first communication device 1012 may be dedicated to shorter-range wireless communications such as Wi-Fi or Bluetooth, and a second communication device 1012 may be dedicated to longer-range wireless communications such as global positioning system (GPS), EDGE, GPRS, CDMA, WiMAX, LTE, EV-DO, or others. In some embodiments, a first communication device 1012 may be dedicated to wireless communications, and a second communication device 1012 may be dedicated to wired communications.

The computing device 1000 may include power source/power circuitry 1014. The power source/power circuitry 1014 may include one or more energy storage devices (e.g., batteries or capacitors) and/or circuitry for coupling components of the computing device 1000 to an energy source separate from the computing device 1000 (e.g., DC power, AC power, etc.).

The computing device 1000 may include a display device 1006 (or corresponding interface circuitry, as discussed above). The display device 1006 may include any visual indicators, such as a heads-up display, a computer monitor, a projector, a touchscreen display, a liquid crystal display (LCD), a light-emitting diode display, or a flat panel display, for example.

The computing device 1000 may include an audio output device 1008 (or corresponding interface circuitry, as discussed above). The audio output device 1008 may include any device that generates an audible indicator, such as speakers, headsets, or earbuds, for example.

The computing device 1000 may include an audio input device 1018 (or corresponding interface circuitry, as discussed above). The audio input device 1018 may include any device that generates a signal representative of a sound, such as microphones, microphone arrays, or digital instruments (e.g., instruments having a musical instrument digital interface (MIDI) output).

The computing device 1000 may include a GPS device 1016 (or corresponding interface circuitry, as discussed above). The GPS device 1016 may be in communication with a satellite-based system and may receive a location of the computing device 1000, as known in the art.

The computing device 1000 may include a sensor 1030 (or one or more sensors). The computing device 1000 may include corresponding interface circuitry, as discussed above). Sensor 1030 may sense physical phenomenon and translate the physical phenomenon into electrical signals that can be processed by, e.g., processing device 1002. Examples of sensor 1030 may include: capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

The computing device 1000 may include another output device 1010 (or corresponding interface circuitry, as discussed above). Examples of the other output device 1010 may include an audio codec, a video codec, a printer, a wired or wireless transmitter for providing information to other devices, haptic output device, gas output device, vibrational output device, lighting output device, home automation controller, or an additional storage device.

The computing device 1000 may include another input device 1020 (or corresponding interface circuitry, as discussed above). Examples of the other input device 1020 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 1000 may have any desired form factor, such as a handheld or mobile computer system (e.g., a cell phone, a smart phone, a mobile internet device, a music player, a tablet computer, a laptop computer, a netbook computer, a personal digital assistant (PDA), an ultramobile personal computer, a remote control, wearable device, headgear, eyewear, footwear, electronic clothing, etc.), a desktop computer system, a server or other networked computing component, a printer, a scanner, a monitor, a set-top box, an entertainment control unit, a vehicle control unit, a digital camera, a digital video recorder, an Internet-of-Things device (e.g., light bulb, cable, power plug, power source, lighting system, audio assistant, audio speaker, smart home device, smart thermostat, camera monitor device, sensor device, smart home doorbell, motion sensor device), a virtual reality system, an augmented reality system, a mixed reality system, or a wearable computer system. In some embodiments, the computing device 1000 may be any other electronic device that processes data.

### Select Examples

Example 1 provides a method, including obtaining a query; randomly sample, from content items corresponding to the query, a number of sampled content items; determining semantic relevance scores corresponding to the sampled content items, where a semantic relevance score measures semantic affinity of a content item to the query; determining bucket identifiers corresponding to the sampled content items; determining, using parameters of an agent model and an embedding of the query, an action vector including weights corresponding to different bucket identifiers; for each sampled content item, scaling the semantic relevance score based on the bucket identifier corresponding to the sampled content item and a weight in the action vector corresponding to the bucket identifier; sorting the sampled content items based on scaled semantic relevance scores; determining a top number of content items having scaled semantic relevance scores; computing a reward based on reward values corresponding to a top number of sampled content items having highest scaled semantic relevance scores; and updating the parameters of the agent model based on the query, the action vector, and the reward.

Example 2 provides the method of example 1, where determining the semantic relevance scores includes determining a first feature vector representing the query; determining second feature vectors representing metadata of the sampled content items respectively; and determining a dot product of the first feature vector and each one of the second feature vectors, where the semantic relevance scores are based on the dot products.

Example 3 provides the method of example 1 or 2, further including updating a trust parameter of an episode based on the reward and a function; and in response to the trust parameter meeting a criterion and a number of rounds completed in the episode has not reached a maximum number, obtaining a further query to complete a further round of the episode.

Example 4 provides the method of example 3, further including in response to the trust parameter not meeting a criterion and the number of rounds completed in an episode has not reached the maximum number, ending the episode.

Example 5 provides the method of example 3 or 4, further including in response to the number of rounds completed in an episode has reached the maximum number, ending the episode.

Example 6 provides the method of any one of examples 3-5, where the reward used in updating the parameters of the agent model is based on an updated value of the trust parameter of the episode.

Example 7 provides the method of any one of examples 1-6, where computing the reward includes summing the reward values corresponding to a top number of sampled content items having highest scaled semantic relevance scores.

Example 8 provides the method of any one of examples 1-7, where computing the reward includes determining a binary flag based on whether a sum of the reward values corresponding to a top number of sampled content items having highest scaled semantic relevance scores is positive or negative.

Example 9 provides the method of any one of examples 1-8, where updating the parameters of the agent model includes calculating a long-term reward based on a weighted sum of the reward and one or more rewards of future rounds in an episode.

Example 10 provides one or more non-transitory computer-readable media having instructions stored thereon, when the instructions are executed by one or more processors, cause the one or more processors to: obtain a query; randomly sample, from content items corresponding to the query, a number of sampled content items; determine semantic relevance scores corresponding to the sampled content items, where a semantic relevance score measures semantic affinity of a content item to the query; determine bucket identifiers corresponding to the sampled content items; determine, using parameters of an agent model and an embedding of the query, an action vector including weights corresponding to different bucket identifiers; for each sampled content item, scale the semantic relevance score based on the bucket identifier corresponding to the sampled content item and a weight in the action vector corresponding to the bucket identifier; sort the sampled content items based on scaled semantic relevance scores; determine a top number of content items having scaled semantic relevance scores; compute a reward based on reward values corresponding to a top number of sampled content items having highest scaled semantic relevance scores; and update the parameters of the agent model based on the query, the action vector, and the reward.

Example 11 provides the one or more non-transitory computer-readable media of example 10, where determining the semantic relevance scores includes determining a first feature vector representing the query; determining second feature vectors representing metadata of the sampled content items respectively; and determining a dot product of the first feature vector and each one of the second feature vectors, where the semantic relevance scores are based on the dot products.

Example 12 provides the one or more non-transitory computer-readable media of example 10 or 11, where the instructions further cause the one or more processors to: update a trust parameter of an episode based on the reward and a function; and in response to the trust parameter meeting a criterion and a number of rounds completed in the episode has not reached a maximum number, obtain a further query to complete a further round of the episode.

Example 13 provides the one or more non-transitory computer-readable media of example 12, where the instructions further cause the one or more processors to: in response to the trust parameter not meeting a criterion and the number of rounds completed in an episode has not reached the maximum number, end the episode.

Example 14 provides the one or more non-transitory computer-readable media of example 12 or 13, where the instructions further cause the one or more processors to: in response to the number of rounds completed in an episode has reached the maximum number, end the episode.

Example 15 provides the one or more non-transitory computer-readable media of any one of examples 12-14, where the reward used in updating the parameters of the agent model is based on an updated value of the trust parameter of the episode.

Example 16 provides the one or more non-transitory computer-readable media of any one of examples 10-15, where computing the reward includes summing the reward values corresponding to a top number of sampled content items having highest scaled semantic relevance scores.

Example 17 provides the one or more non-transitory computer-readable media of any one of examples 10-16, where computing the reward includes determining a binary flag based on whether a sum of the reward values corresponding to a top number of sampled content items having highest scaled semantic relevance scores is positive or negative.

Example 18 provides the one or more non-transitory computer-readable media of any one of examples 10-17, where updating the parameters of the agent model includes calculating a long-term reward based on a weighted sum of the reward and one or more rewards of future rounds in an episode.

Example 19 provides a method, including obtaining a context; randomly sample, from content items corresponding to the context, a number of sampled content items; determining contextual relevance scores corresponding to the sampled content items, where a contextual relevance score measures contextual affinity of a content item to the context; determining bucket identifiers corresponding to the sampled content items; determining, using parameters of an agent model and an embedding of the context, an action vector including weights corresponding to different bucket identifiers; for each sampled content item, scaling the contextual relevance score based on the bucket identifier corresponding to the sampled content item and a weight in the action vector corresponding to the bucket identifier; sorting the sampled content items based on scaled contextual relevance scores; determining a top number of content items having scaled contextual relevance scores; computing a reward based on reward values corresponding to a top number of content items having highest scaled contextual relevance scores; and updating the parameters of the agent model based on the context, the action vector, and the reward.

Example 20 provides the method of example 19, where determining the contextual relevance scores includes determining a first feature vector representing the context; determining second feature vectors representing metadata of the sampled content items respectively; and determining a dot product of the first feature vector and each one of the second feature vectors, where the contextual relevance scores are based on the dot products.

Example 21 provides the method of example 19 or 20, further including updating a trust parameter of an episode based on the reward and a function; and in response to the trust parameter meeting a criterion and a number of rounds completed in the episode has not reached a maximum number, obtaining a further context to complete a further round of the episode.

Example 22 provides the method of example 21, further including in response to the trust parameter not meeting a criterion and the number of rounds completed in an episode has not reached the maximum number, ending the episode.

Example 23 provides the method of example 21 or 22, further including in response to the number of rounds completed in an episode has reached the maximum number, ending the episode.

Example 24 provides the method of any one of examples 21-23, where the reward used in updating the parameters of the agent model is based on an updated value of the trust parameter of the episode.

Example 25 provides the method of any one of examples 19-24, where computing the reward includes summing the reward values corresponding to a top number of sampled content items having highest scaled contextual relevance scores.

Example 26 provides the method of any one of examples 19-25, where computing the reward includes determining a binary flag based on whether a sum of the reward values corresponding to a top number of sampled content items having highest scaled contextual relevance scores is positive or negative.

Example 27 provides the method of any one of examples 19-26, where updating the parameters of the agent model includes calculating a long-term reward based on a weighted sum of the reward and one or more rewards of future rounds in an episode.

Example A provides one or more non-transitory computer-readable media storing instructions that, when executed by one or more processors, cause the one or more processors to perform any one of the methods provided in examples 1-9 and 19-27.

Example B provides an apparatus comprising means to carry out or means for carrying out any one of the computer-implemented methods provided in examples 1-9 and 19-27.

Example C provides a computer-implemented system, comprising one or more processors, and one or more non-transitory computer-readable media storing instructions that, when executed by the one or more processors, cause the one or more processors to perform any one of the methods provided in examples 1-9 and 19-27.

Example D provides a computer-implemented system comprising one or more components illustrated in FIG. 5 to perform operations described herein.

### Variations and Other Notes

Although the operations of the example methods shown in and described with reference to the FIGS. are illustrated as occurring once each and in a particular order, it will be recognized that the operations may be performed in any suitable order and repeated as desired. Additionally, one or more operations may be performed in parallel. Furthermore, the operations illustrated in the FIGS. may be combined or may include more or fewer details than described.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

1. A method, comprising:
obtaining a query;
randomly sample, from content items corresponding to the query, a number of sampled content items;
determining semantic relevance scores corresponding to the sampled content items, wherein a semantic relevance score measures semantic affinity of a content item to the query;
determining bucket identifiers corresponding to the sampled content items;
determining, using parameters of an agent model and an embedding of the query, an action vector comprising weights corresponding to different bucket identifiers;
for each sampled content item, scaling the semantic relevance score based on the bucket identifier corresponding to the sampled content item and a weight in the action vector corresponding to the bucket identifier;
sorting the sampled content items based on scaled semantic relevance scores;
determining a top number of content items having scaled semantic relevance scores;
computing a reward based on reward values corresponding to a top number of sampled content items having highest scaled semantic relevance scores; and
updating the parameters of the agent model based on the query, the action vector, and the reward.

2. The method of claim 1, wherein determining the semantic relevance scores comprises:
determining a first feature vector representing the query;
determining second feature vectors representing metadata of the sampled content items respectively; and
determining a dot product of the first feature vector and each one of the second feature vectors, wherein the semantic relevance scores are based on the dot products.

3. The method of claim 1, further comprising:
updating a trust parameter of an episode based on the reward and a function; and
in response to the trust parameter meeting a criterion and a number of rounds completed in the episode has not reached a maximum number, obtaining a further query to complete a further round of the episode.

4. The method of claim 3, further comprising:
in response to the trust parameter not meeting a criterion and the number of rounds completed in an episode has not reached the maximum number, ending the episode.

5. The method of claim 3, further comprising:
in response to the number of rounds completed in an episode has reached the maximum number, ending the episode.

6. The method of claim 3, wherein the reward used in updating the parameters of the agent model is based on an updated value of the trust parameter of the episode.

7. The method of claim 1, wherein computing the reward comprises:
summing the reward values corresponding to a top number of sampled content items having highest scaled semantic relevance scores.

8. The method of claim 1, wherein computing the reward comprises:
determining a binary flag based on whether a sum of the reward values corresponding to a top number of sampled content items having highest scaled semantic relevance scores is positive or negative.

9. The method of claim 3, wherein updating the parameters of the agent model comprises calculating a long-term reward based on a weighted sum of the reward and one or more rewards of future rounds in an episode.

10. One or more non-transitory computer-readable media having instructions stored thereon, when the instructions are executed by one or more processors, cause the one or more processors to:
obtain a query;
randomly sample, from content items corresponding to the query, a number of sampled content items;
determine semantic relevance scores corresponding to the sampled content items, wherein a semantic relevance score measures semantic affinity of a content item to the query;
determine bucket identifiers corresponding to the sampled content items;
determine, using parameters of an agent model and an embedding of the query, an action vector comprising weights corresponding to different bucket identifiers;
for each sampled content item, scale the semantic relevance score based on the bucket identifier corresponding to the sampled content item and a weight in the action vector corresponding to the bucket identifier;
sort the sampled content items based on scaled semantic relevance scores;
determine a top number of content items having scaled semantic relevance scores;
compute a reward based on reward values corresponding to a top number of sampled content items having highest scaled semantic relevance scores; and
update the parameters of the agent model based on the query, the action vector, and the reward.

11. The one or more non-transitory computer-readable media of claim 10, wherein determining the semantic relevance scores comprises:
determining a first feature vector representing the query;
determining second feature vectors representing metadata of the sampled content items respectively; and
determining a dot product of the first feature vector and each one of the second feature vectors, wherein the semantic relevance scores are based on the dot products.

12. The one or more non-transitory computer-readable media of claim 10, wherein the instructions further cause the one or more processors to:
update a trust parameter of an episode based on the reward and a function; and
in response to the trust parameter meeting a criterion and a number of rounds completed in the episode has not reached a maximum number, obtain a further query to complete a further round of the episode.

13. The one or more non-transitory computer-readable media of claim 12, wherein the instructions further cause the one or more processors to:
in response to the trust parameter not meeting a criterion and the number of rounds completed in an episode has not reached the maximum number, end the episode.

14. The one or more non-transitory computer-readable media of claim 12, wherein the instructions further cause the one or more processors to:
in response to the number of rounds completed in an episode has reached the maximum number, end the episode.

15. The one or more non-transitory computer-readable media of claim 12, wherein the reward used in updating the parameters of the agent model is based on an updated value of the trust parameter of the episode.

16. The one or more non-transitory computer-readable media of claim 10, wherein computing the reward comprises:
summing the reward values corresponding to a top number of sampled content items having highest scaled semantic relevance scores.

17. The one or more non-transitory computer-readable media of claim 10, wherein computing the reward comprises:
determining a binary flag based on whether a sum of the reward values corresponding to a top number of sampled content items having highest scaled semantic relevance scores is positive or negative.

18. The one or more non-transitory computer-readable media of claim 10, wherein updating the parameters of the agent model comprises calculating a long-term reward based on a weighted sum of the reward and one or more rewards of future rounds in an episode.

19. A method, comprising:
obtaining a context;
randomly sample, from content items corresponding to the context, a number of sampled content items;
determining contextual relevance scores corresponding to the sampled content items, wherein a contextual relevance score measures contextual affinity of a content item to the context;
determining bucket identifiers corresponding to the sampled content items;
determining, using parameters of an agent model and an embedding of the context, an action vector comprising weights corresponding to different bucket identifiers;
for each sampled content item, scaling the contextual relevance score based on the bucket identifier corresponding to the sampled content item and a weight in the action vector corresponding to the bucket identifier;
sorting the sampled content items based on scaled contextual relevance scores;
determining a top number of content items having scaled contextual relevance scores;
computing a reward based on reward values corresponding to a top number of content items having highest scaled contextual relevance scores; and
updating the parameters of the agent model based on the context, the action vector, and the reward.

20. The method of claim 19, wherein determining the contextual relevance scores comprises:
determining a first feature vector representing the context;
determining second feature vectors representing metadata of the sampled content items respectively; and
determining a dot product of the first feature vector and each one of the second feature vectors, wherein the contextual relevance scores are based on the dot products.
